(19) United States
(12) Patent Application Publication
(10) Pub. No.: US 2017/0153468 A1
(43) Pub. Date: Jun. 1, 2017

(54) LIQUID CRYSTAL DISPLAY DEVICE

(71) Applicant: InnoLux Corporation, Jhu-Nan (TW)

(72) Inventor: Yung-Shun YANG, Jhu-Nan (TW)

(21) Appl. No.: 15/360,015

(22) Filed: Nov. 23, 2016

(30) Foreign Application Priority Data
Nov. 27, 2015 (CN) 201510847038.7

(51) Int. Cl. G02F 1/137; G02F 1/1333; G02F 1/1343

(52) U.S. Cl. CPC G02F 1/137; G02F 1/134309; G02F 1/133345; G02F 2201/121; G02F 2001/134372; G02F 2001/134345; G02F 2201/123

(57) ABSTRACT

A LCD device includes a first substrate, a second substrate, a liquid crystal layer and at least one subpixel. The liquid crystal layer and the subpixel are disposed between the first and second substrates. The subpixel includes a first electrode disposed over the first substrate, a first insulation layer disposed over the first electrode, a second electrode disposed over the first insulation layer, a second insulation layer disposed over the second electrode, and a third electrode disposed over the second insulation layer. The rotation of liquid crystal molecules of the liquid crystal layer in the subpixel is controlled by a voltage difference of the first electrode and the third electrode or a voltage difference of the second electrode and the third electrode within a frame time.

### CROSS REFERENCE TO RELATED APPLICATIONS

This Non-provisional application claims priority under 35 U.S.C. §119(a) on Patent Application No(s). 201510847038.7 filed in People's Republic of China on Nov. 27, 2015, the entire contents of which are hereby incorporated by reference.

### BACKGROUND

Technical Field

The present invention relates to a display device and, in particular, to a liquid crystal display device.

Related Art

As the progress of technology, the flat display device has been widely applied to various fields. In particular, the liquid crystal display (LCD) device has the advantages of light, thin, low power consumption, and no radiation, so it gradually replaces the traditional CRT display device. The LCD device can be applied to many electronic devices such as mobile phone, portable multimedia device, laptop computer, LCD TV and LCD monitor.

The LCD device mainly includes a LCD panel and a backlight module, which are disposed opposite to each other. The LCD panel includes a color filter (CF) substrate, a thin-film-transistor (TFT) substrate, and a liquid crystal layer disposed between the substrates. The CF substrate, the TFT substrate and the liquid crystal layer form a plurality of subpixels arranged in an array. The light emitted from the backlight module passes through the LCD panel, and forms an image after passing through the subpixels of the LCD panel.

Recently, an FFS (fringe field switching) LCD device, which can improve the response time of liquid crystal molecules, has been developed. In the FFS LCD device, the rotation switching time of the liquid crystal molecules can be reduced. In more detailed, an electrode is provided to cover the entire subpixel of the CF substrate. When applying a high voltage to the electrode in a short time, a very strong vertical electric field can be applied to the liquid crystal molecule in a short time so as to force the liquid crystal molecule to rotate, thereby speeding the response time of the liquid crystal. However, this approach with the large-sized electrode will decrease the transmittance of the entire panel during the normal displaying. Besides, in order to prevent the large difference of the response times of the first and last rows of subpixels in the display area, the electrode of the CF substrate must be divided into several sections. However, the divided sections of electrode will cause a difficult in layout and in applying electronic signals.

### SUMMARY

The disclosure provides a liquid crystal display device that has faster response time of the liquid crystal than the conventional liquid crystal display devices.

To achieve the above, the disclosure discloses a liquid crystal display device including a first substrate, a second substrate, a liquid crystal layer and at least one subpixel. The liquid crystal layer is disposed between the first substrate and the second substrate. The subpixel is disposed between the first substrate and the second substrate, and includes a first electrode, a first insulation layer, a second electrode, a second insulation layer, and a third electrode. The first electrode is disposed over the first substrate, and the first insulation layer is disposed over the first electrode. The second electrode is disposed over the first insulation layer and has a plurality of linear electrodes. The second insulation layer is disposed over the second electrode, and the third electrode is disposed over the second insulation layer and has a plurality of linear electrodes. A rotation of liquid crystal molecules of the liquid crystal layer in the subpixel is controlled by a voltage difference of the first electrode and the third electrode or a difference of the second electrode and the third electrode within a frame time.

In one embodiment, the subpixel further includes a data line, and the third electrode is electrically connected to the data line to form a pixel electrode. The first electrode is a common electrode. The rotation of the liquid crystal molecules of the liquid crystal layer in the subpixel is controlled by the voltage difference of the first electrode and the second electrode within a liquid crystal recovery time, and the liquid crystal recovery time is between the frame time and a next frame time.

In one embodiment, the linear electrodes of the third electrode extend along a first direction, and the linear electrodes of the second electrode extend along a second direction. The first direction is different from the second direction, and the first electrode is distributed in the entire area of the subpixel.

In one embodiment, the first direction is substantially parallel to a liquid crystal alignment direction of the subpixel, and an included angle between the second direction and the liquid crystal alignment direction of the subpixel is greater than or equal to 80 degrees and is smaller than or equal to 120 degrees.

In one embodiment, the first direction is substantially perpendicular to a liquid crystal alignment direction of the subpixel, and an included angle between the second direction and the liquid crystal alignment direction of the subpixel is greater than or equal to −10 degrees and is smaller than or equal to 30 degrees.

To achieve the above, the disclosure discloses another liquid crystal display device, which includes a first substrate, a second substrate, a liquid crystal layer and at least one subpixel. The liquid crystal layer is disposed between the first substrate and the second substrate. The subpixel is disposed between the first substrate and the second substrate, and includes a first electrode disposed over the first substrate, a first insulation layer disposed over the first electrode, a second electrode disposed over the first insulation layer and having a plurality of linear electrodes, a second insulation layer disposed over the second electrode, and a third electrode disposed over the second insulation layer and having two linear electrodes extending along a first direction. A rotation of liquid crystal molecules of the liquid crystal layer in the subpixel is controlled by a voltage difference of the first electrode and the second electrode within a frame time.

In one embodiment, the subpixel further includes a data line, and the second electrode is electrically connected to the data line to form a pixel electrode. The first electrode is a common electrode and is distributed in the entire area of the subpixel. The rotation of the liquid crystal molecules of the liquid crystal layer in the subpixel is controlled by the voltage difference of the first electrode and the third electrode within a liquid crystal recovery time, and the liquid crystal recovery time is between the frame time and a next frame time.

In one embodiment, the two linear electrodes of the third electrode extend along the first direction, and the linear electrodes of the second electrode extend along a second direction. The first direction is different from the second direction, and the linear electrodes of the third electrode are located at two opposite sides of the second electrode.

To achieve the above, the disclosure further discloses another liquid crystal display device, which includes a first substrate, a second substrate, a liquid crystal layer disposed between the first substrate and the second substrate, and at least one subpixel disposed between the first substrate and the second substrate. The subpixel includes a first electrode disposed over the first substrate, a first insulation layer disposed over the first electrode, a second electrode disposed over the first insulation layer and having a plurality of linear electrodes, a second insulation layer disposed over the second electrode, and a third electrode disposed over the second insulation layer and having two linear electrodes extending along a first direction. The linear electrodes of the third electrode are located at two opposite sides of the second electrode. A rotation of liquid crystal molecules of the liquid crystal layer in the subpixel is controlled by a voltage difference of the first electrode and the second electrode within a frame time.

In one embodiment, the subpixel further includes a data line, and the first electrode is electrically connected to the data line to form a pixel electrode and is distributed in the entire area of the subpixel. The rotation of the liquid crystal molecules of the liquid crystal layer in the subpixel is controlled by the voltage difference of the second electrode and the third electrode within a liquid crystal recovery time. The liquid crystal recovery time is between the frame time and a next frame time. The second electrode is a common electrode. The linear electrodes of the second electrode extend along a second direction, and the first direction is different from the second direction.

As mentioned above, in the liquid crystal display device of the disclosure, the first electrode of the subpixel is disposed over the first substrate, the first insulation layer is disposed over the first electrode, the second electrode is disposed over the first insulation layer, the second insulation layer is disposed over the second electrode, and the third electrode is disposed over the second insulation layer. The rotation of the liquid crystal molecules of the liquid crystal layer in the subpixel is controlled by a voltage difference of the first and third electrodes or the second and third electrodes within a frame time. Alternatively, in other embodiments, the rotation of liquid crystal molecules of the liquid crystal layer in the subpixel is controlled by a voltage difference of the first and second electrodes within a frame time. Compared to the conventional art, the liquid crystal display device of the disclosure can reduce the rotation switching time so as to achieve the faster response time of the liquid crystal.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1A is a top view of a part of a subpixel of a liquid crystal display device according to an embodiment of the disclosure;

FIG. 1B and FIG. 1C are sectional views of the subpixel of FIG. 1A along the line A-A and the line B-B;

FIG. 1D and FIG. 1E are schematic diagrams showing the extension direction of the linear electrodes of the second electrode and the alignment direction of the liquid crystal;

FIG. 1F is a sectional view of the subpixel of FIG. 1A along the line C-C;

FIG. 2 is a schematic diagram showing the transmittance vs. time of the liquid crystal display device according to an embodiment;

FIG. 3A is a top view of a part of a subpixel of a liquid crystal display device according to another embodiment of the disclosure;

FIG. 3B and FIG. 3C are sectional views of the subpixel of FIG. 3A along the line D-D and the line E-E; and

FIG. 4A and FIG. 4B are schematic diagrams showing the arrangements of multiple subpixels and the third electrode of different aspects.

### DETAILED DESCRIPTION OF THE INVENTION

The embodiments of the invention will be apparent from the following detailed description, which proceeds with reference to the accompanying drawings, wherein the same references relate to the same elements.

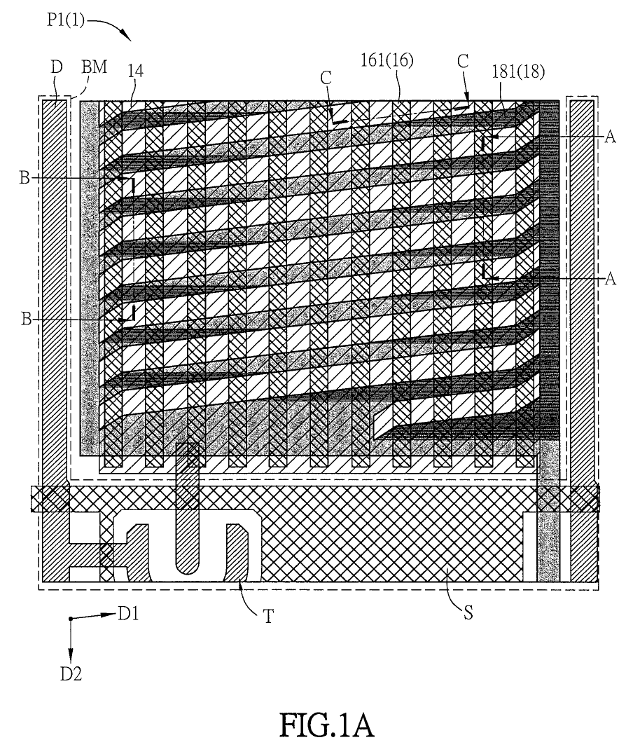

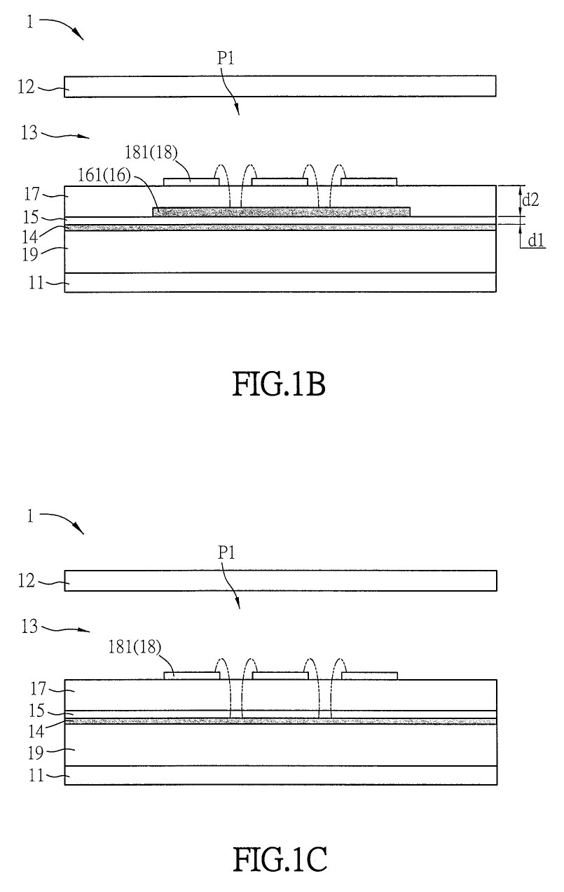

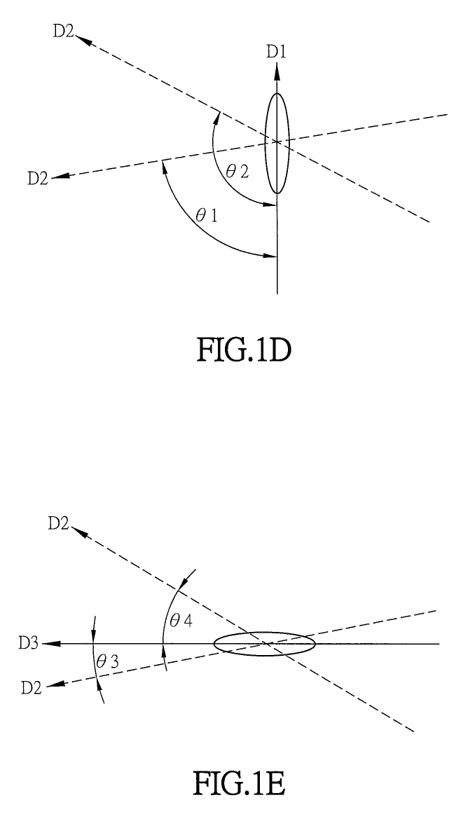

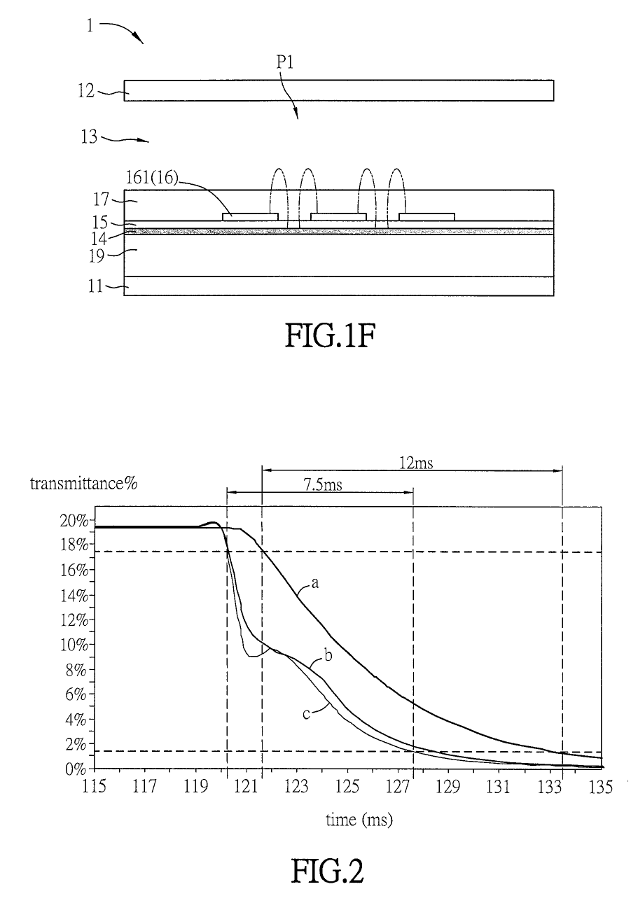

FIG. 1A is a top view of a part of a subpixel P1 of a liquid crystal display (LCD) device 1 according to an embodiment of the disclosure, and FIGS. 1B and 1C are sectional views of the subpixel P1 of FIG. 1A along the line A-A and the line B-B. To be noted, FIG. 1A only shows the first electrode 14, the second electrode 16, the third electrode 18, the scan line S, the data line D, the black matrix BM and the thin-film transistor T, and the other components of the LCD device 1 or the subpixel P1 are not shown. Besides, FIG. 1B further shows the first substrate 11 and the second substrate 12.

In this embodiment, the LCD device 1 is, for example but not limited to, a FFS LCD device or any other horizontal electric-field LCD device. As shown in FIG. 1B, the LCD device 1 includes a first substrate 11, a second substrate 12 and a liquid crystal layer 13. The first substrate 11 is disposed opposite to the second substrate 12, and the liquid crystal layer 13 is sandwiched between the first substrate 11 and the second substrate 12. The first substrate 11 and the second substrate 12 can be made of a light permeable material such as a glass substrate, a quartz substrate or a plastic substrate, and this invention is not limited.

The LCD device 1 further includes a subpixel array (not shown), which is composed of a CF (color filter) array and a TFT array (not shown). Basically, the subpixel array is configured between the first substrate 11 and the second substrate 12, and includes a plurality of subpixels, which are arranged in an array. Herein, FIG. 1A only shows a subpixel P1. Besides, the LCD device 1 further includes a plurality of scan lines S and a plurality of data lines D, which are crossly disposed to define the subpixels P1. The TFT array has a plurality of thin-film transistors T disposed corresponding to the subpixels P1. The gate of each thin-film transistor T is electrically connected to a scan line S corresponding to the subpixel P1, and the source/drain of the thin-film transistor T is electrically connected to a data line D corresponding to the subpixel P1. The source/drain of the thin-film transistor T is electrically connected to the pixel electrode of the subpixel P1 through a via.

The subpixel P1 is disposed over the first substrate 11 and has a first electrode 14, a first insulation layer 15, a second electrode 16, a second insulation layer 17, and a third electrode 18. In addition, the subpixel P1 further includes a third insulation layer 19 and a data line D, which are disposed over the first substrate 11. As shown in FIG. 1B, the third insulation layer 19, the first electrode 14, the first insulation layer 15, the second electrode 16, the second insulation layer 17, and the third electrode 18 are disposed over the first substrate 11 in sequence. Besides, the data line D is also disposed over the first substrate 11, and the third insulation layer 19 covers the data line D and the first substrate 11. In this embodiment, the first electrode 14 is a plate electrode in the subpixel P1. In other words, the first electrode 14 is formed on the entire area of the subpixel P1 and covers the third insulation layer 19. Accordingly, the third insulation layer 19 is disposed between the data line D and the first electrode 14 for preventing the short circuit thereof.

To be noted, the order and relations of the above-mentioned layers of this embodiment are for an illustration only, and it is still possible to add other layers or structures between any of the above layers based on different manufacturing processes, products or structures.

In this embodiment, the first insulation layer 15 is disposed over the first electrode 14, and the second electrode 16 is disposed over the first insulation layer 15. Accordingly, the first insulation layer 15 is sandwiched between the first electrode 14 and the second electrode 16 for preventing the short circuit thereof. The second insulation layer 17 is disposed over the second electrode 16, and the third electrode 18 is disposed over the second insulation layer 17. Accordingly, the third electrode 18 is disposed between the second insulation layer 17 and the liquid crystal layer 13. The second insulation layer 17 can prevent the short circuit of the second electrode 16 and the third electrode 18. In this case, the thickness d1 of the first insulation layer 15 can be smaller than or equal to the thickness d2 of the second insulation layer 17. The ratio of the thickness d1 of the first insulation layer 15 to the thickness d2 of the second insulation layer 17 can be greater than or equal to 1/10 and smaller than or equal to 1 (1/10≦(d1/d2)≦1).

The first insulation layer 15, the second insulation layer 17 and the third insulation layer 19 can be made of, for example but not limited to, the polymer material, silicon oxide (SiOx), silicon nitride (SiNx), or other insulation materials. Each of the first electrode 14, the second electrode 16 and the third electrode 18 can be a transparent electrode, which can be made of, for example but not limited to, ITO (indium-tin oxide) or IZO (indium-zinc oxide). In this embodiment, the third electrode 18 can be a pixel electrode electrically connected to the data line D (not shown). When the LCD device 1 is in a normal displaying, the first electrode 14 and the second electrode 16 are common electrodes, which are applied with a common voltage.

The first electrode 14 of this embodiment can be a plate electrode. Different from the first electrode 14, the third electrode 18 includes a plurality of linear electrodes 181 extending along a first direction D1, and the second electrode 16 includes a plurality of linear electrode 161 extending along a second direction D2. The first direction D1 is different from the second direction D2. In one embodiment, if the liquid crystal layer 13 contains positive liquid crystal molecules, the first direction D1 is substantially parallel to the liquid crystal alignment direction of the subpixel P1. As shown in FIG. 1D, the included angle between the second direction D2 and the liquid crystal alignment direction of the subpixel P1 (the first direction D1) can be between θ1 and θ2. In this case, θ1 is 80 degrees, and θ2 is 120 degrees. Since the liquid crystal layer 13 is affected by the structure of the alignment layer and thus aligned toward the alignment direction, the axial direction of the liquid crystal molecules of the liquid crystal layer 13 is the liquid crystal alignment direction formed in the rubbing process.

In another embodiment, if the liquid crystal layer 13 contains negative liquid crystal molecules, the first direction D1 is substantially perpendicular to the liquid crystal alignment direction of the subpixel P1. As shown in FIG. 1E, the included angle between the second direction D2 and the liquid crystal alignment direction of the subpixel P1 (the direction D3) can be between θ3 and θ4. In this case, the included angle between the second direction D2 and the liquid crystal alignment direction of the subpixel P1 (the direction D3) can be greater than or equal to −10 degrees (θ3) and smaller than or equal to 30 degrees (θ4).

As shown in FIG. 1B, the LCD device 1 may further include a black matrix BM and a CF layer (not shown). The black matrix BM can be disposed over the first substrate 11 or the second substrate 12, corresponding to the data line D. The black matrix BM can be made of an opaque material such as metal or resin. Herein, the metal can be chromium, chromium oxide or chromium oxynitride. In this embodiment, the black matrix BM is disposed over one side of the second substrate 12 facing the first substrate 11, and located above the data line D. Accordingly, when viewing from the top side of the LCD device 1, the black matrix BM covers the data line D as well as the scan line S. In addition, the CF layer (not shown) can be disposed over one side of the second substrate 12 and the black matrix BM facing the first substrate 11, or can be disposed over the first substrate 11. Since the black matrix BM is made of an opaque material, it can form an opaque area on the second substrate 12 so as to define the light-permeable area. In this embodiment, the black matrix BM and the CF layer are disposed over the second substrate 12. In other embodiments, the black matrix BM or the CF layer can be disposed over the first substrate 11 so as to form a BOA (BM on array) substrate or a COA (color filter on array) substrate, and this invention is not limited.

The LCD device 1 may further include a protective layer such as a cover-coating (not shown), which can cover the black matrix BM and the CF layer. The protective layer can be made of a photoresist material, a resin material or an inorganic material, such as SiOx or SiNx, for protecting the black matrix BM and the CF layer in the following processes. In addition, the LCD device 1 may further include two alignment layers (not shown). One alignment layer covers the third electrode 18, and the other one is disposed over one side of the black matrix BM and the CF layer facing the first substrate 11.

As mentioned above, when the scan line S of the LCD device 1 receives a scan signal, the thin-film transistor T of the subpixel P1 corresponding to the scan line S is turned on so as to transmit a data signal of the corresponding column of subpixels P1 to the pixel electrode of the corresponding subpixel P1. Accordingly, the LCD device 1 can display the desired image. The gray-level adjustment of the subpixel P1 of the LCD device 1 within a frame time (normal displaying) is performed by controlling the rotation of the liquid crystal in the liquid crystal layer 13 by the voltage difference of the first electrode 14 and the third electrode 18 or by the voltage difference of the second electrode 16 and the third electrode 18.

In this embodiment, as shown in FIG. 1B, the gray-level voltage of the subpixel P1 within a frame time can be transmitted from each data line D to the third electrode 18 (pixel electrode) of each subpixel P1, thereby forming an electric field between the third electrode 18 and the second electrode 16 (common electrode) for driving the liquid crystal molecules of the liquid crystal layer 13 to rotate so as to modulate the light for displaying the image by the LCD device 1. As shown in FIG. 1C, the gray-level voltage of the subpixel P1 within a frame time can also be transmitted from each data line D to the third electrode 18 (pixel electrode) of each subpixel P1, thereby forming an electric field between the third electrode 18 and the first electrode 14 (common electrode) for driving the liquid crystal molecules of the liquid crystal layer 13 to rotate so as to modulate the light for displaying the image by the LCD device 1. To be noted, in one embodiment, since the thickness d1 of the first insulation layer 15 is very thin, the electric field between the third electrode 18 and the second electrode 16 is similar to that between the third electrode 18 and the first electrode 14. Herein, the thickness d1 of the first insulation layer 15 is, for example, 500 Å.

FIG. 1F is a sectional view of the subpixel P1 of FIG. 1A along the line C-C.

The rotation of the liquid crystal of the liquid crystal layer 13 in the subpixel P1 is controlled by the voltage difference of the first electrode 14 and the second electrode 16 within a liquid crystal recovery time. The liquid crystal recovery time is between the frame time and a next frame time. In other words, as shown in FIG. 1F, after the LCD device 1 displays a frame and before it displays the next frame (within a liquid crystal recovery time), the third electrode 18 (pixel electrode) is floating and the second electrode 16 (common electrode) is still applied with the common voltage signal. In order to speed the response time of the liquid crystal molecules, the first electrode 14 is applied with a pulse signal (one or more pulses) with a higher voltage (e.g. 10V or 20V). In one embodiment, the linear electrodes 161 of the second electrode 16 extend along the second direction D2. The included angle between the second direction D2 and the liquid crystal alignment direction (positive liquid crystal) of the subpixel P1 can be greater than or equal to 80 degrees and is smaller than or equal to 120 degrees. In another embodiment, the linear electrodes 161 of the second electrode 16 extend along the second direction D2, and the included angle between the second direction D2 and the liquid crystal alignment direction (negative liquid crystal) of the subpixel P1 can be greater than or equal to −10 degrees and is smaller than or equal to 30 degrees. In this case, the direction of the stronger electric field generated between the first electrode 14 and the second electrode 16 is the same as the liquid crystal alignment direction, or they can have a very small included angle. Accordingly, the liquid crystal molecules can be rapidly recovered to the arrangement of the dark state by the stronger electric field. Compared with the conventional FFS LCD device, the LCD device 1 of this embodiment can decrease the switching time of the liquid crystal molecules so as to reduce the falling time.

In other embodiments, different driving methods can be applied for achieving the goal of decreasing the switching time of the liquid crystal molecules. After the LCD device 1 displays a frame and before it switches to the next frame, the third electrode 18 is still floating and the first electrode 14 is applied with the common voltage signal. The linear electrodes 161 are applied with a positive-negative-alternated pulse signal with a higher voltage. In more detailed, a positive pulse signal, a negative pulse signal, a positive pulse signal, a negative pulse signal, . . . , etc. are subsequently applied to the linear electrodes 161. This approach can not only make the direction of the stronger electric field generated between the first electrode 14 and the second electrode 16 to be the same as the liquid crystal alignment direction (or they can have a very small included angle) so as to decrease the switching time of the liquid crystal molecules, but also improve the incorrect cross-voltage issue of the subpixel P1 caused by the signal coupling between the first electrode 14 and the second electrode 16. The positive and negative signal coupling can be offset.

FIG. 2 is a schematic diagram showing the transmittance vs. time of the LCD device according to an embodiment

As shown in FIG. 2, the curve a shows the transmittance vs. time of the conventional FFS LCD device. Curve a shows the transmittance vs. time of a conventional FFS liquid crystal device. Curves b and c show the transmittance vs. time of the LCD device 1 of the above embodiments. In the case of curve b, the third electrode 18 is floating, the second electrode 16 is applied with a common voltage signal, and the first electrode 14 is applied with a pulse signal (20V/3 ms). In the case of curve c, the third electrode 18 is floating, the second electrode 16 is applied with a common voltage signal, and the first electrode 14 is applied with two pulse signals (30V/1 ms and 20V/1 ms).

With reference to FIG. 2, the falling time (referring to the time that the brightness falls from 90% to 10%) of the conventional FFS LCD device is about 12 ms. Regarding to the curve b, the falling time is about 7.5 ms. Regarding to the curve c, the falling time is about 7 ms. As a result, compared with the conventional FFS LCD device, the LCD device 1 of this embodiment has a faster liquid crystal response time.

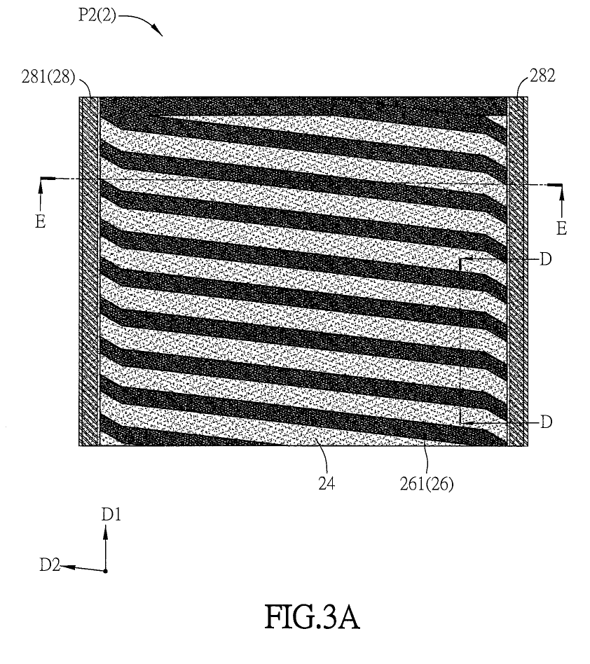

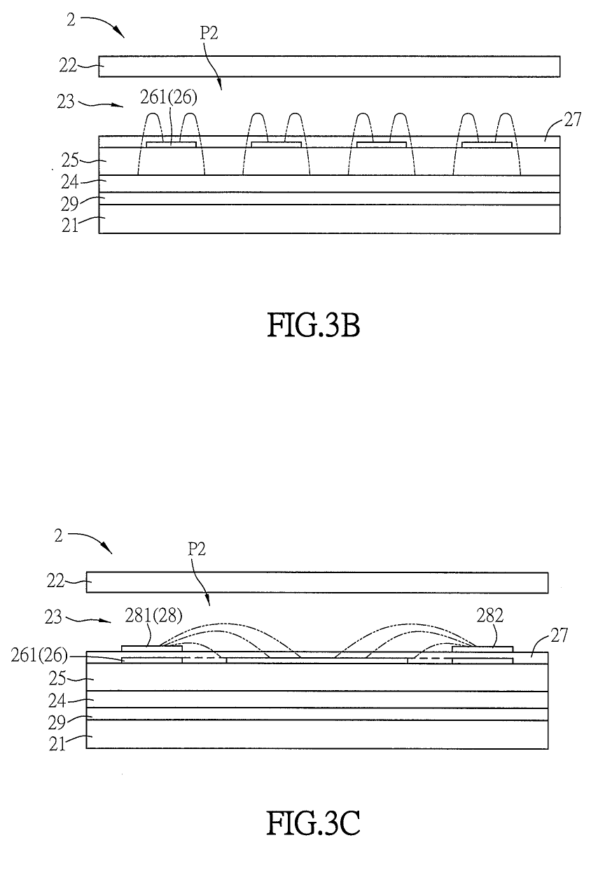

FIG. 3A is a top view of a part of a subpixel P2 of an LCD device 2 according to another embodiment of the disclosure, and FIG. 3B and FIG. 3C are sectional views of the subpixel P2 of FIG. 3A along the line D-D and the line E-E. To be noted, FIG. 3A only shows the first electrode 24, the second electrode 26 and the third electrode 28 of the subpixel P2, and the other components of the LCD device 2 or the subpixel P2 are not shown.

In this embodiment, the LCD device 2 is, for example but not limited to, a FFS LCD device or any other horizontal electric-field LCD device. The LCD device 2 includes a first substrate 21, a second substrate 22 and a liquid crystal layer 23. The first substrate 21 is disposed opposite to the second substrate 22, and the liquid crystal layer 23 is sandwiched between the first substrate 21 and the second substrate 22. The first substrate 21 and the second substrate 22 can be made of a light permeable material such as a glass substrate, a quartz substrate or a plastic substrate, and this invention is not limited.

The LCD device 2 further includes a subpixel array (not shown), which is composed of a CF array and a TFT array (not shown). Basically, the subpixel array is configured between the first substrate 21 and the second substrate 22, and includes a plurality of subpixels, which are arranged in an array. Herein, FIG. 3A only shows a subpixel P2. Besides, the LCD device 2 further includes a plurality of scan lines (not shown) and a plurality of data lines D (not shown), which are crossly disposed to define the subpixels P2. The TFT array has a plurality of thin-film transistors (not shown) disposed corresponding to the subpixels P2. The gate of each thin-film transistor is electrically connected to a scan line corresponding to the subpixel, and the source/drain of the thin-film transistor is electrically connected to a data line corresponding to the subpixel. The source/drain of the thin-film transistor is electrically connected to the pixel electrode of the subpixel P2 through a via.

The subpixel P2 is disposed over the first substrate 21 and has a first electrode 24, a first insulation layer 25, a second electrode 26, a second insulation layer 27, and a third electrode 28. In addition, the subpixel P2 further includes a third insulation layer 29 and a data line, which are disposed over the first substrate 21. As shown in FIGS. 3A and 3B, the third insulation layer 29, the first electrode 24 (and the data line), the first insulation layer 25, the second electrode 26, the second insulation layer 27, and the third electrode 28 are disposed over the first substrate 21 in sequence. The third insulation layer 29 is disposed over the first substrate 21, and the first electrode 24 is a plate electrode distributed in the subpixel P2 and is disposed over the third insulation layer 29. The data line is also disposed over the third insulation layer 29. The first insulation layer 25 covers the first electrode 24 and the data line. The second electrode 26 is disposed over the first insulation layer 25, so that the first insulation layer 25 is disposed between the data line, the first electrode 24 and the second electrode 26 for preventing the short circuit thereof. The second insulation layer 27 covers the second electrode 26. The third electrode 28 includes two linear electrodes 281 and 282 extending along the first direction D1. When viewing from the top side of the subpixel P2, the linear electrodes 281 and 282 are located corresponding to the opposite two sides of the second electrode 26 (e.g. the left and right sides), and are disposed between the liquid crystal layer 23 and the second insulation layer 27. The second insulation layer 27 can prevent the short circuit of second electrode 26 and the third electrode 28. In a different aspect, the linear electrodes 281 and 282 can be located at the top and bottom sides of the second electrode 26, and this invention is not limited.

The first insulation layer 25, the second insulation layer 27 and the third insulation layer 29 can be made of, for example but not limited to, the polymer material, silicon oxide (SiOx), silicon nitride (SiNx), or other insulation materials. Each of the first electrode 24, the second electrode 26 and the third electrode 28 can be a transparent electrode, which is made of, for example but not limited to, ITO (indium-tin oxide) or IZO (indium-zinc oxide), and this invention is not limited. In this embodiment, the first electrode 24 can be a pixel electrode electrically connected to the data line (not shown). When the LCD device 2 is in a normal displaying, the second electrode 26 is a common electrode, which is applied with a common voltage. This is a top common aspect.

The first electrode 24 of this embodiment can be a plate electrode distributed in the subpixel P2. The second electrode 26 includes a plurality of linear electrode 261 extending along the second direction D2, and the linear electrodes 281 and 282 of the third electrode 28 extend along the first direction D1 and are located corresponding to the opposite two sides of the second electrode 26 (the left and right sides). The first direction D1 is different from the second direction D2. In one embodiment, if the liquid crystal layer 23 contains positive liquid crystal molecules, the first direction D1 is substantially parallel to the liquid crystal alignment direction of the subpixel P2. The included angle between the second direction D2 and the liquid crystal alignment direction of the subpixel P2 can be greater than or equal to 80 degrees and smaller than or equal to 120 degrees. In another embodiment, if the liquid crystal layer 23 contains negative liquid crystal molecules, the first direction D1 is substantially perpendicular to the liquid crystal alignment direction of the subpixel P2. The included angle between the second direction D2 and the liquid crystal alignment direction of the subpixel P2 can be greater than or equal to −10 degrees and is smaller than or equal to 30 degrees.

Moreover, the LCD device 2 may further include a black matrix and a CF layer (not shown). The black matrix can be disposed over the first substrate 21 or the second substrate 22 corresponding to the data line. The black matrix can be made of an opaque material such as metal or resin. Herein, the metal can be chromium, chromium oxide or chromium oxynitride. In this embodiment, the black matrix can be disposed over one side of the second substrate 22 facing the first substrate 21, and located above the data line. Accordingly, when viewing from the top side of the LCD device 2, the black matrix covers the data line. In addition, the CF layer (not shown) can be disposed over one side of the second substrate 22 and the black matrix facing the first substrate 21, or can be disposed over the first substrate 21. Since the black matrix is made of an opaque material, it can form an opaque area on the second substrate 22 so as to define the light-permeable area. In this embodiment, the black matrix and the CF layer are disposed over the second substrate 22. In other embodiments, the black matrix or the CF layer can be disposed over the first substrate 21 so as to form a BOA (BM on array) substrate or a COA (color filter on array) substrate, and this invention is not limited.

The LCD device 2 may further include a protective layer such as a cover-coating (not shown), which can cover the black matrix and the CF layer. The protective layer can be made of a photoresist material, a resin material or an inorganic material, such as SiOx or SiNx, for protecting the black matrix and the CF layer in the following processes. In addition, the LCD device 2 may further include two alignment layers (not shown). One alignment layer covers the third electrode 28, and the other one is disposed over one side of the black matrix and the CF layer facing the first substrate 21.

As mentioned above, when the scan line of the LCD device 2 receives a scan signal, the thin-film transistor of the subpixel P2 corresponding to the scan line is turned on so as to transmit a data signal of the corresponding column of subpixels P2 to the pixel electrode of the corresponding subpixel P2. Accordingly, the LCD device 2 can display the desired image. The gray-level adjustment of the subpixel P2 of the LCD device 2 within a frame time (normal displaying) is performed by controlling the rotation of the liquid crystal in the liquid crystal layer 23 by the voltage difference of the first electrode 24 and the second electrode 26. In this embodiment, as shown in FIG. 3B, the gray-level voltage of the subpixel P2 within a frame time can be transmitted from each data line to the first electrode 24 of each subpixel P2, thereby forming an electric field between the first electrode 24 (pixel electrode) and the second electrode 26 (common electrode) for driving the liquid crystal molecules of the liquid crystal layer 23 to rotate so as to modulate the light for displaying the image by the LCD device 2.

The switch (frame switching) of the subpixel P2 within a liquid crystal recovery time is performed by the voltage difference of the second electrode 26 and the third electrode 28. The liquid crystal recovery time is between the frame time and a next frame time. In other words, as shown in FIG. 3C, after the LCD device 2 displays a frame and before it displays the next frame (the switch moment of the subpixel P2 from the bright state to the dark state), the first electrode 24 is floating and the second electrode 26 is still applied with the common voltage signal. In order to speed the response time of the liquid crystal molecules, the third electrode 28 is applied with a pulse signal (one or more pulses) with a higher voltage (e.g. 10V or 20V). In one embodiment, the linear electrodes 281 and 282 of the third electrode 28 extend along the first direction D1 and are located at opposite two sides of the second electrode 26. The first direction D1 is substantially parallel to the liquid crystal alignment direction of the subpixel P2, and the linear electrodes 261 of the second electrode 26 extend along the second direction D2. The included angle between the second direction D2 and the liquid crystal alignment direction (positive liquid crystal) of the subpixel P2 can be greater than or equal to 80 degrees and smaller than or equal to 120 degrees. In another embodiment, the linear electrodes 281 and 282 of the third electrode 28 extend along the first direction D1 and are located at opposite two sides of the second electrode 26. The first direction D1 is substantially perpendicular to the liquid crystal alignment direction of the subpixel P2, and the linear electrodes 261 of the second electrode 26 extend along the second direction D2. The included angle between the second direction D2 and the liquid crystal alignment direction (negative liquid crystal) of the subpixel P2 can be greater than or equal to −10 degrees and smaller than or equal to 30 degrees (between −10 and 30 degrees). In this case, the direction of the stronger electric field generated between the second electrode 26 and the third electrode 28 is the same as the liquid crystal alignment direction, or they can have a very small included angle. Accordingly, the liquid crystal molecules can be rapidly recovered to the arrangement of the dark state by the stronger electric field. Compared with the conventional FFS LCD device, the LCD device 2 of this embodiment can have a faster liquid crystal response time.

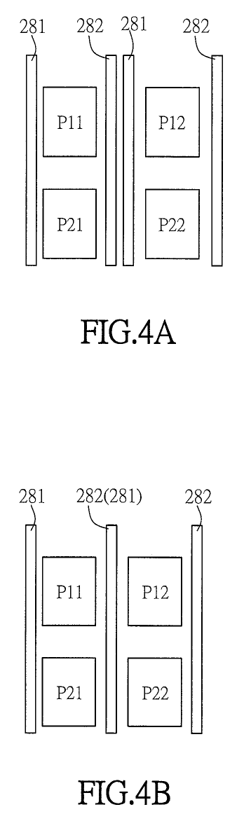

FIG. 4A and FIG. 4B are schematic diagrams showing the arrangements of multiple subpixels P11 to P22 and the third electrode 28 of different aspects.

In the aspect of FIG. 4A, the left and right sides of each of the subpixels P11 to P22 are configured with two linear electrodes 281 and 281, respectively. Accordingly, there are one linear electrode 281 and one linear electrode 282 configured between the subpixels P11 and P12 and between the subpixels P21 and P22. In the aspect of FIG. 4B, there is only one linear electrode 281 or 282 configured between the subpixels P11 and P12 and between the subpixels P21 and P22. This invention is not limited to the aspect of FIG. 4A or FIG. 4B.

In the LCD device 2, the first electrode 24 can be a pixel electrode, and the second electrode 26 can be a common electrode as the LCD device 2 is in a normal displaying (top common type). In another embodiment (not shown), the second electrode 26 of the subpixel can be a pixel electrode and electrically connected to the data line, and the first electrode 24 can be a common electrode and applied with a common voltage as the LCD device 2 is in a normal displaying (top pixel type). In the top pixel type, the gray-level adjustment of the subpixel within a frame time is also performed by controlling the rotation of the liquid crystal in the liquid crystal layer 23 by the voltage difference of the first electrode 24 (common electrode) and the second electrode 26 (pixel electrode). But, the switch of the subpixel in a liquid crystal recovery time (between one frame and the next frame) is performed by controlling the rotation of the liquid crystal in the liquid crystal layer 23 by the voltage difference of the first electrode 24 and the third electrode 28.

In other words, in the top pixel type, after the LCD device displays a frame and before it switches to the next frame, the second electrode 26 (pixel electrode) is floating and the first electrode 24 is still applied with the common voltage signal. In order to speed the response time of the liquid crystal molecules, the third electrode 28 is applied with a pulse signal with a higher voltage (e.g. 10V or 20V). Accordingly, the direction of the stronger electric field generated between the first electrode 24 and the third electrode 28 is the same as the liquid crystal alignment direction, or they can have a very small included angle. Thus, the liquid crystal molecules can be rapidly recovered to the arrangement of the dark state by the stronger electric field. Compared with the conventional FFS LCD device, the LCD device of this embodiment can decrease the switching time of the liquid crystal molecules so as to reduce the falling time.

The other technical features of the top pixel type LCD device can be referred to the illustration of the LCD device 2, so the detailed description thereof will be omitted.

To sum up, in the liquid crystal display device of the disclosure, the first electrode of the subpixel is disposed over the first substrate, the first insulation layer is disposed over the first electrode, the second electrode is disposed over the first insulation layer, the second insulation layer is disposed over the second electrode, and the third electrode is disposed over the second insulation layer. The rotation of the liquid crystal molecules of the liquid crystal layer in the subpixel is controlled by a voltage difference of the first and third electrodes or the second and third electrodes within a frame time. Alternatively, the rotation of liquid crystal molecules of the liquid crystal layer in the subpixel is controlled by a voltage difference of the first and second electrodes within a frame time. Compared to the conventional art, the liquid crystal display device of the disclosure can reduce the rotation switching time so as to achieve the faster response time of the liquid crystal.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display device, comprising:
a first substrate;
a second substrate;
a liquid crystal layer disposed between the first substrate and the second substrate; and
at least a subpixel disposed between the first substrate and the second substrate, and comprising:
a first electrode disposed over the first substrate,
a first insulation layer disposed over the first electrode,
a second electrode disposed over the first insulation layer and having a plurality of linear electrodes,
a second insulation layer disposed over the second electrode, and
a third electrode disposed over the second insulation layer and having a plurality of linear electrodes;
wherein a rotation of liquid crystal molecules of the liquid crystal layer in the subpixel is controlled by a voltage difference of the first electrode and the third electrode or a voltage difference of the second electrode and the third electrode within a frame time.

2. The liquid crystal display device according to claim 1, wherein the subpixel further comprises a data line, the third electrode is electrically connected to the data line to form a pixel electrode, the first electrode is a common electrode, the rotation of the liquid crystal molecules of the liquid crystal layer in the subpixel is controlled by the voltage difference of the first electrode and the second electrode within a liquid crystal recovery time, and the liquid crystal recovery time is between the frame time and a next frame time.

3. The liquid crystal display device according to claim 1, wherein the linear electrodes of the third electrode extend along a first direction, the linear electrodes of the second electrode extend along a second direction, the first direction is different from the second direction, and the first electrode is distributed in the entire area of the subpixel.

4. The liquid crystal display device according to claim 3, wherein the first direction is substantially parallel to a liquid crystal alignment direction of the subpixel, and an included angle between the second direction and the liquid crystal alignment direction of the subpixel is greater than or equal to 80 degrees and is smaller than or equal to 120 degrees.

5. The liquid crystal display device according to claim 3, wherein the first direction is substantially perpendicular to a liquid crystal alignment direction of the subpixel, and an included angle between the second direction and the liquid crystal alignment direction of the subpixel is greater than or equal to −10 degrees and is smaller than or equal to 30 degrees.

6. A liquid crystal display device, comprising:
a first substrate;
a second substrate;
a liquid crystal layer disposed between the first substrate and the second substrate; and
at least a subpixel disposed between the first substrate and the second substrate, and comprising:
a first electrode disposed over the first substrate,
a first insulation layer disposed over the first electrode,
a second electrode disposed over the first insulation layer and having a plurality of linear electrodes,
a second insulation layer disposed over the second electrode, and
a third electrode disposed over the second insulation layer and having two linear electrodes extending along a first direction;
wherein a rotation of liquid crystal molecules of the liquid crystal layer in the subpixel is controlled by a voltage difference of the first electrode and the second electrode within a frame time.

7. The liquid crystal display device according to claim 6, wherein the subpixel further comprises a data line, the second electrode is electrically connected to the data line to form a pixel electrode, the first electrode is a common electrode and is distributed in the entire area of the subpixel, the rotation of the liquid crystal molecules of the liquid crystal layer in the subpixel is controlled by the voltage difference of the first electrode and the third electrode within a liquid crystal recovery time, and the liquid crystal recovery time is between the frame time and a next frame time.

8. The liquid crystal display device according to claim 7, wherein the two linear electrodes of the third electrode extend along the first direction, the linear electrodes of the second electrode extend along a second direction, the first direction is different from the second direction, and the linear electrodes of the third electrode are located at two opposite sides of the second electrode.

9. A liquid crystal display device, comprising:
a first substrate;
a second substrate;
a liquid crystal layer disposed between the first substrate and the second substrate; and
at least a subpixel disposed between the first substrate and the second substrate, and comprising:
a first electrode disposed over the first substrate,
a first insulation layer disposed over the first electrode,
a second electrode disposed over the first insulation layer and having a plurality of linear electrodes,
a second insulation layer disposed over the second electrode, and
a third electrode disposed over the second insulation layer and having two linear electrodes extending along a first direction, wherein the linear electrodes of the third electrode are located at two opposite sides of the second electrode;
wherein a rotation of liquid crystal molecules of the liquid crystal layer in the subpixel is controlled by a voltage difference of the first electrode and the second electrode within a frame time.

10. The liquid crystal display device according to claim 9, wherein the subpixel further comprises a data line, the first electrode is electrically connected to the data line to form a pixel electrode and is distributed in the entire area of the subpixel, the rotation of the liquid crystal molecules of the liquid crystal layer in the subpixel is controlled by the voltage difference of the second electrode and the third electrode within a liquid crystal recovery time, the liquid crystal recovery time is between the frame time and a next frame time, the second electrode is a common electrode, the linear electrodes of the second electrode extend along a second direction, and the first direction is different from the second direction.
